(19) United States
(12) Patent Application Publication
(10) Pub. No.: US 2009/0262639 A1
(43) Pub. Date: Oct. 22, 2009

(54) LAND PREPIT SIGNAL DETECTING CIRCUIT

(75) Inventor: Tsuyoshi Hamaguchi, Kyoto (JP)

Correspondence Address: CANTOR COLBURN, LLP, 20 Church Street, 22nd Floor, Hartford, CT, 06103, US

(73) Assignee: ROHM CO., LTD., Kyoto (JP)

(21) Appl. No.: 11/995,607

(22) PCT Filed: Jul. 12, 2006
(86) PCT No.: PCT/JP2006/313880

§ 371 Date: Jan. 14, 2008

(30) Foreign Application Priority Data
Jul. 14, 2005 (JP) 2005-205093

(51) Int. Cl. G11B 7/24

(52) U.S. Cl. 369/275.4; G9B/7

(57) ABSTRACT

A threshold voltage generating circuit detects the amplitude ΔV of the wobble signal included in the push-pull signal, and generates a threshold voltage Vth based upon the amplitude ΔV of the wobble signal thus detected. A first filter removes the high-frequency components from the push-pull signal, thereby extracting the wobble signal. A peak hold circuit holds the peak value of the wobble signal thus extracted by the first filter. A second filter extracts a DC signal which is the DC component of the push-pull signal. An amplifier amplifies the difference ΔV between the output of the peak hold circuit and the output of the second filter, i.e., the amplitude of the wobble signal.

### BACKGROUND OF THE INVENTION

1. Field of the Invention

The present invention relates to an optical disk device which offers data writing, and particularly to a technique for detecting a land pre-pit signal employed in an optical disk device such as DVD-Rs, DVD-RWs, etc.

2. Description of the Related Art

Optical disks such as CDs (Compact Discs), DVDs (Digital Versatile Discs), and so forth, have come to be very widely used as recording media for audio and video information. The disks such as DVD-Rs, DVD-RWs, and so forth have a function of high density data recording and reading. In order to enable the address information to be managed, and in order to enable the rotation control to be performed, such a disk has grooves, i.e., so-called wobble grooves, formed in a substrate of the disk in the form of spiral grooves that deviate from a perfect spiral by a predetermined cycle frequency. Furthermore, land pre-pits are formed on the lands, each of which is a region between the adjacent grooves. The land pre-pits provide information to assist in the addressing.

At the time of writing or reading out requested information to or from such an optical disk, laser light is irradiated onto the optical disk, and the reflected light is detected by an optical pick-up. The signal thus detected by the optical pick-up is amplified, thereby outputting a push-pull signal in which a wobble signal corresponding to the wobble grooves and a land pre-pit signal corresponding to the land pre-pits are superimposed. The optical disk device detects the wobble signal and the land pre-pit signal from the push-pull signal in order to manage the address information. For example, Patent documents 1 and 2 disclose techniques for detecting the land pre-pit signal from the push-pull signal.

### [Patent Document 1]

Japanese Patent Application Laid-open No. 2003-123260

### [Patent Document 2]

Japanese Patent Application Laid-open No. 2005-78686

With the technique disclosed in Patent document 2, high-frequency components are removed from a push-pull signal, thereby obtaining a slew rate signal with the same frequency and the same amplitude as those of the wobble signal. Furthermore, the slew rate signal is smoothed, thereby obtaining a smoothed signal. With such a technique, the smoothed signal thus obtained is used as a threshold voltage (slice signal) for detecting the land pre-pit signal.

However, let us consider a case in which noise has occurred near the maximum value (or the minimum value) of the wobble signal. With such a technique, in some case, such noise can be erroneously detected as a land pre-pit signal.

### SUMMARY OF THE INVENTION

The present invention has been made in view of the aforementioned problems. Accordingly, it is a general purpose of the present invention to provide a land pre-pit signal detection circuit that provides a function of detecting a land pre-pit signal with higher precision and an optical disk device employing the aforementioned land pre-pit signal detection circuit.

An embodiment of the present invention relates to a land pre-pit signal detection circuit for extracting a land pre-pit signal from a push-pull signal. The land pre-pit signal detection circuit comprises: a threshold voltage generating circuit which detects the amplitude of a wobble signal included in the push-pull signal, and which generates a threshold voltage based upon the amplitude of the wobble signal thus detected; and a comparator which compares the push-pull signal with the threshold voltage, and determines whether the land pre-pit signal is present or absent.

With such an embodiment, the threshold voltage for detecting the land pre-pit signal is changed according to the change in the amplitude of the wobble signal, thereby enabling the land pre-pit signal to be detected with high precision.

The threshold voltage generating circuit may comprise: a first filter which removes high-frequency components from the push-pull signal so as to extract the wobble signal; a peak hold circuit which holds the peak value of the wobble signal thus extracted by the first filter; a second filter which extracts the DC component from the push-pull signal; and an amplifier which amplifies the difference between the output of the peak hold circuit and the output of the second filter, thereby generating the threshold voltage which is a predetermined multiple of the amplitude of the wobble signal.

With such an embodiment, the threshold voltage is suitably generated based upon the amplitude of the wobble signal by amplifying the difference between the peak value and the DC value of the wobble signal.

Also, the amplifier may be a variable-gain amplifier. With such an arrangement, the gain of the amplifier can be changed. Such an arrangement allows the threshold voltage to be set to a suitable value according to the kind of pick-up provided upstream of the land pre-pit signal detection circuit, the kind of optical disk medium from which data is to be read or to which data is to be written, or the rotational speed of the optical disk.

The threshold voltage generating circuit may further include a voltage dividing circuit which performs voltage dividing using the output of the amplifier and the peak hold circuit. With such an arrangement, the output of the voltage dividing circuit is output as the threshold voltage. Also, the voltage dividing circuit has a configuration which allows the voltage dividing ratio to be adjusted.

Such an arrangement allows the threshold voltage to be set to a value higher than the maximum value of the wobble signal in a sure manner.

The land pre-pit signal detection circuit may be integrally formed on a single semiconductor substrate. Examples of “integrally formed circuits” include: an arrangement in which all the components of a circuit are formed on a semiconductor substrate; and an arrangement in which the principal components of a circuit are integrally formed, and a part comprising resistors or capacitors for adjusting the circuit constants is provided external to the semiconductor substrate.

Another embodiment of the present invention relates to an optical disk device. The optical disk device comprises: a pick-up which reads out information that has been written to a disk; and the aforementioned land pre-pit signal detection circuit, which detects a land pre-pit signal from a push-pull signal read out by the pick-up.

Such an embodiment enables the land pre-pit signal to be detected with high precision.

Note that any combination of the aforementioned components or any manifestation of the present invention realized by replacement of a method, a device, a system, and so forth, is effective as an embodiment of the present invention.

It is to be noted that any arbitrary combination or rearrangement of the above-described structural components and so forth is effective as and encompassed by the present embodiments.

Moreover, this summary of the invention does not necessarily describe all necessary features so that the invention may also be a sub-combination of these described features.

### BRIEF DESCRIPTION OF THE DRAWINGS

Embodiments will now be described, by way of example only, with reference to the accompanying drawings which are meant to be exemplary, not limiting, and wherein like elements are numbered alike in several Figures, in which:

FIG. 1 is a circuit diagram which shows a configuration of a land pre-pit signal detection circuit according to an embodiment.

FIG. 2 is a block diagram which shows a configuration of an optical disk device employing the land pre-pit signal detection circuit shown in FIG. 1.

FIGS. 3A through 3C are operation waveform diagrams for the land pre-pit signal detection circuit shown in FIG. 1.

FIG. 4 is a circuit diagram which shows a modification of the land pre-pit signal detection circuit shown in FIG. 1.

FIG. 5 is an operation waveform diagram for the land pre-pit signal detection circuit shown in FIG. 4.

### DETAILED DESCRIPTION OF THE INVENTION

The invention will now be described based on preferred embodiments which do not intend to limit the scope of the present invention but exemplify the invention. All of the features and the combinations thereof described in the embodiment are not necessarily essential to the invention.

Description will be made below regarding preferred embodiments according to the present invention with reference to the drawings. The same or similar components, members, and processes are denoted by the same reference numerals, and redundant description thereof will be omitted. The embodiments have been described for exemplary purposes only, and are by no means intended to restrict the present invention. Also, it is not necessarily essential for the present invention that all the features or a combination thereof be provided as described in the embodiments.

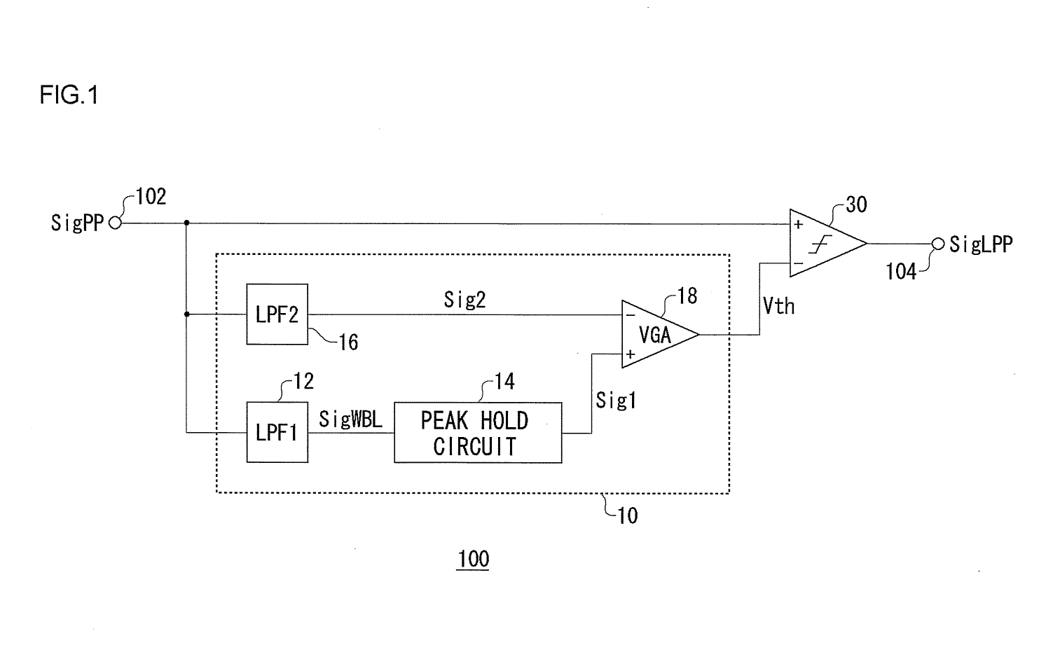

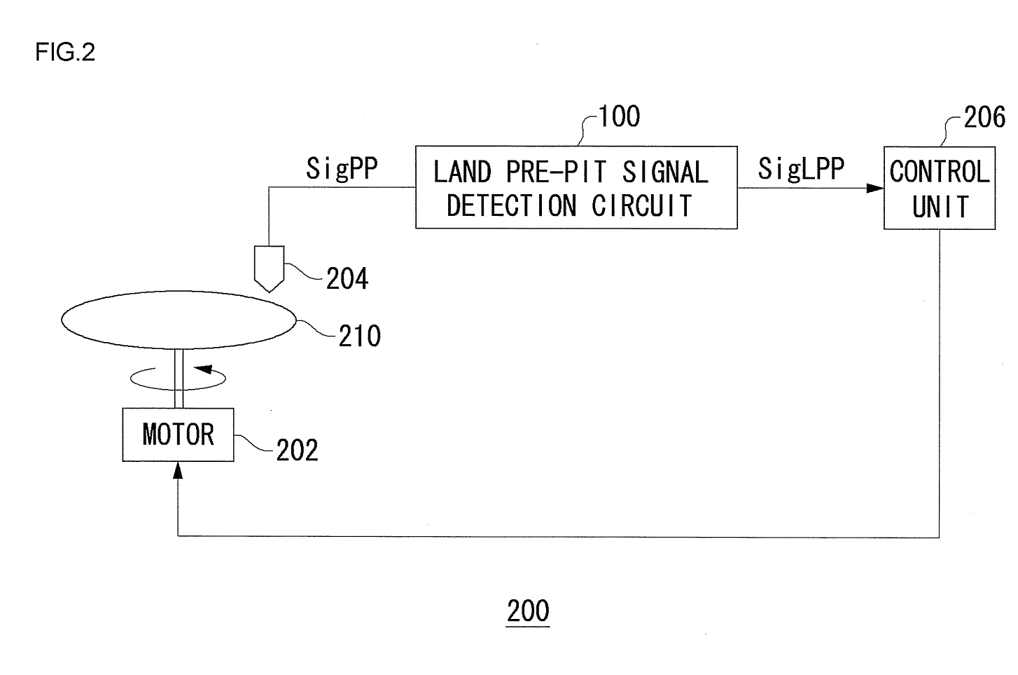

FIG. 1 is a circuit diagram which shows a configuration of a land pre-pit signal detection circuit 100 according to the present embodiment. On the other hand, FIG. 2 is a block diagram which shows a configuration of an optical disk device 200 employing the land pre-pit signal detection circuit 100 shown in FIG. 1.

The optical disk device 200 shown in FIG. 2 is employed as a built-in device included in an electronic apparatus such as a personal computer, a DVD recorder, etc., which provides a function of recording and reading video data, audio data, etc., in the form of digital data. The optical disk device 200 includes a spindle motor 202, an optical disk 210, a pick-up 204, a land pre-pit signal detection circuit 100, and a control unit 206.

The pick-up 204 irradiates laser light onto the optical disk 210, detects the reflected light, and amplifies the signal thus detected, thereby reading out the data recorded on the optical disk 210 in the form of an electrical signal. More specifically, the pick-up 204 irradiates the laser light onto the grooves and the lands adjacent to the grooves so as to detect a push-pull signal SigPP in which a wobble signal and a land pre-pit signal, which corresponds to the land pre-pits formed on the lands, are superimposed. The push-pull signal SigPP thus detected is output to the land pre-pit signal detection circuit 100.

The land pre-pit signal detection circuit 100 extracts the land pre-pit signal SigLPP from the push-pull signal SigPP, and outputs the land pre-pit signal SigLPP to the control unit 206. The control unit 206 acquires the address information and so forth from the land pre-pit signal SigLPP, which is used for controlling the spindle motor 202 or the pickup 204. Returning to FIG. 1, detailed description will be made below regarding the configuration of the land pre-pit signal detection circuit 100 according to the present embodiment.

The land pre-pit signal detection circuit 100 detects the land pre-pit signal SigLPP from the push-pull signal SigPP input to an input terminal 102, and outputs the push-pull signal SigPP via an output terminal 104. The land pre-pit signal detection circuit 100 according to the present embodiment is integrally formed on a single semiconductor substrate. With such an arrangement, the land pre-pit signal detection circuit 100 may be provided in the form of a single LSI. Also, the land pre-pit signal detection circuit 100 may be provided in the form of an analog front-end (AFE) circuit further including integrated upstream or downstream functional blocks.

The land pre-pit signal detection circuit 100 includes a threshold voltage generating circuit 100 and a comparator 30. The threshold voltage generating circuit 10 detects the amplitude of the wobble signal SigWBL included in the push-pull signal SigPP, and generates a threshold voltage Vth based upon the amplitude of the wobble signal SigWBL thus detected.

The threshold voltage generating circuit 10 includes a first filter 12, a peak hold circuit 14, a second filter 16, and an amplifier 18.

The first filter 12 removes the high-frequency components from the push-pull signal SigPP, thereby extracting the wobble signal SigWBL. Here, the cut-off frequency of the first filter 12 is determined such that it allows the first filter 12 to remove the noise component and the land pre-pit signal SigLPP from the push-pull signal SigPP.

The peak hold circuit 14 holds the peak value of the wobble signal SigWBL extracted by the first filter 12. The output signal from the peak hold circuit 14 will be referred to as a peak signal Sig1.

The second filter 16 extracts the DC component of the push-pull signal SigPP. With such an arrangement, the cut-off frequency of the second filter 16 is set such that it is sufficiently smaller than the cut-off frequency of the first filter 12. The output signal of the second filter 16 will be referred to as a DC signal Sig2.

The amplifier 18 is a variable gain amplifier, which amplifies the signal that represents the difference between the output of the peak hold circuit 14 and the output of the second filter 16. With such an arrangement, the gain g of the amplifier 18 is controlled according to an unshown control signal. The output signal of the amplifier 18 is output as the threshold voltage Vth.

The comparator 30 compares the push-pull signal SigPP with the threshold voltage Vth output from the threshold voltage generating circuit 10, and determines whether or not the push-pull signal SigPP includes the land pre-pit signal SigLPP.

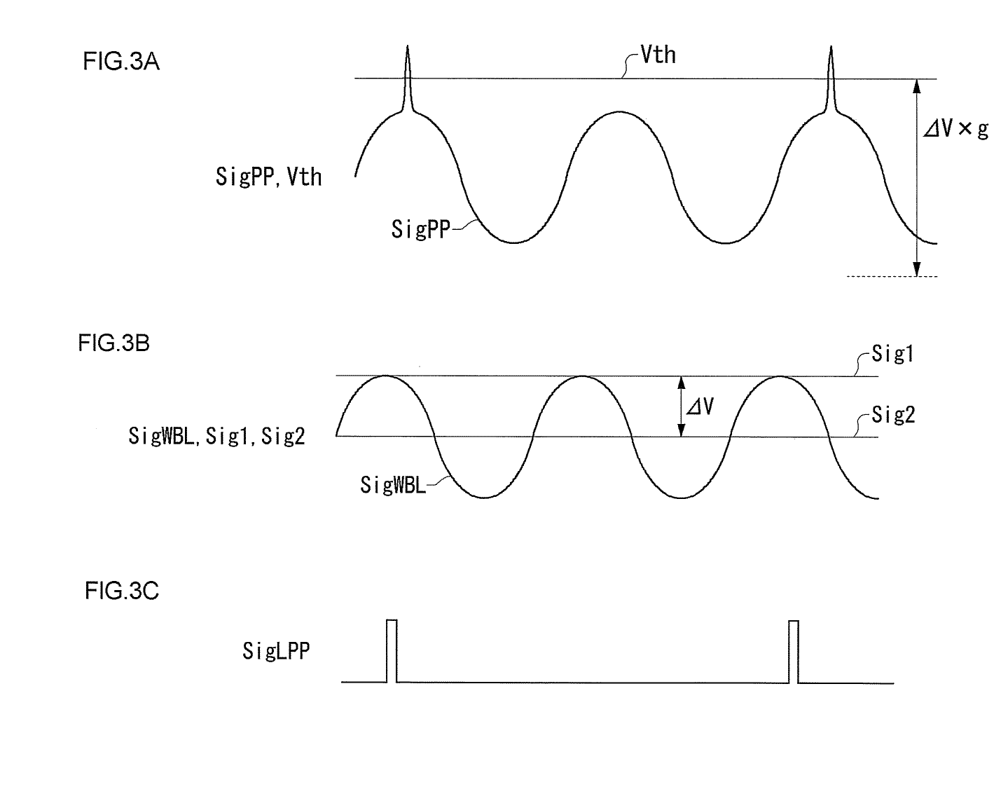

Description will be made regarding the operation of the land pre-pit signal detection circuit 100 having the aforementioned configuration. FIGS. 3A through 3C are operation waveform diagrams for the land pre-pit signal detection circuit 100 shown in FIG. 1. FIG. 3A shows the push-pull signal SigPP and the threshold voltage Vth. FIG. 3B shows the wobble signal SigWBL, the peak signal Sig1, and the DC signal Sig2. FIG. 3C shows the land pre-pit signal SigLPP.

The push-pull signal SigPP shown in FIG. 3A, in which a wobble signal and a land pre-pit signal are superimposed, is input to the input terminal 102 of the land pre-pit signal detection circuit 100. The push-pull signal SigPP is input to the first filter 12, the second filter 16, and the comparator 30.

The first filter 12 removes the high-frequency components from the push-pull signal SigPP, and thus removes the land pre-pit signal from the push-pull signal SigPP, thereby outputting the wobble signal SigWBL shown in FIG. 3B. The peak hold circuit 14 holds the peak value of the wobble signal SigWBL, thereby generating the peak signal Sig1. On the other hand, the second filter 16 extracts the DC component of the push-pull signal SigPP, thereby generating the DC signal Sig2.

The amplifier 18 amplifies the difference ΔV between the peak signal Sig1 and the DC signal Sig2 by the gain g, thereby generating the threshold voltage Vth. Here, the difference ΔV between the peak signal Sig1 and the DC signal Sig2 matches the amplitude of the wobble signal SigWBL. The comparator 30 compares the push-pull signal SigPP with the threshold voltage Vth. In a case that SigPP is greater than Vth, the comparator 30 outputs the land pre-pit signal SigLPP as a high level signal.

As described above, with the land pre-pit signal detection circuit 100 according to the present embodiment, the threshold voltage Vth is changed according to the change in the amplitude ΔV of the wobble signal SigWBL. Such an arrangement allows the land pre-pit signal SigLPP to be detected with high precision.

The gain g of the amplifier 18 may be changed according to the kind of pick-up 204 provided upstream of the land pre-pit signal detection circuit 100, the kind of medium, i.e., the kind of optical disk 210 from which data is to be read or to which data is to be written, or the rotational speed of the optical disk 210. Such an arrangement allows the threshold voltage Vth for detecting the land pre-pit signal to be suitably adjusted according to the operating conditions of the optical disk device 200.

Note that it is not necessarily essential to employ a variable gain amplifier as the amplifier 18. Also, an arrangement may be made employing a fixed gain amplifier as the amplifier 18. Such an arrangement provides a simpler circuit configuration.

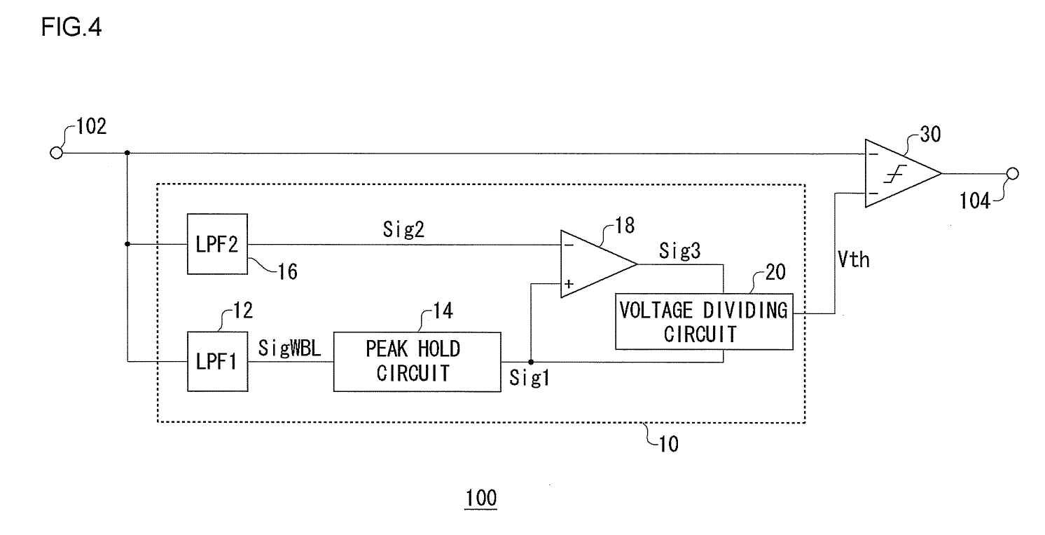

FIG. 4 is a circuit diagram which shows a modification of the land pre-pit signal detection circuit 100 shown in FIG. 1. In FIG. 4, the same components as those shown in FIG. 1 are denoted by the same reference numerals, and description thereof will be omitted as appropriate.

The threshold voltage generating circuit 10 shown in FIG. 4 further includes a voltage dividing circuit 20 for dividing the peak signal Sig1, which is the output of the peak hold circuit 14. With such an arrangement, the output signal of the voltage dividing circuit 20 is output as the threshold voltage Vth. Let us say that the voltage dividing circuit 20 provides a voltage dividing ratio of a:b. In this case, the threshold voltage Vth is represented by the expression Vth (a×Sig1+b×Sig3)/(a+b). The voltage dividing circuit 20 may be configured according to known techniques.

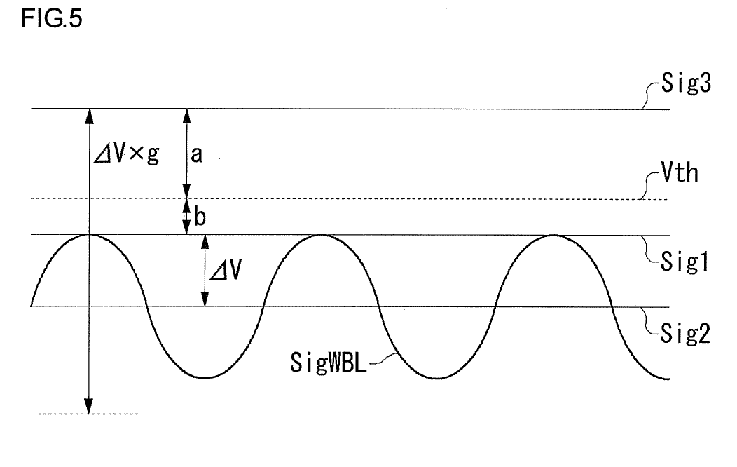

FIG. 5 is an operation waveform diagram for the land pre-pit signal detection circuit 100 shown in FIG. 4. The amplitude ΔV of the wobble signal SigWBL is amplified by the amplifier 18, thereby generating the signal Sig3. The gain g of the amplifier 18 is determined so as to satisfy the condition Sig3>Sig1. The threshold voltage Vth is generated by voltage dividing using the output signal Sig3 of the amplifier 18 and the peak signal Sig1.

Also, an arrangement may be made in which the amplifier 18 provides a fixed gain g and the voltage dividing circuit 20 provides an adjustable voltage dividing ratio. With such an arrangement, the threshold voltage Vth can be adjusted by controlling the voltage dividing ratio. Also, an arrangement may be made in which a variable gain amplifier is employed as the amplifier 18, and the voltage dividing circuit 20 provides an adjustable voltage dividing ratio. With such an arrangement, the threshold voltage Vth can be adjusted so as to be shifted to the higher voltage side or the lower voltage side by controlling both the gain g and the voltage dividing ratio.

The above-described embodiments have been described for exemplary purposes only, and are by no means intended to be interpreted restrictively. Rather, it can be readily conceived by those skilled in this art that various modifications may be made by making various combinations of the aforementioned components or processes, which are also encompassed in the technical scope of the present invention.

Description has been made in the aforementioned embodiments regarding an arrangement in which the land pre-pit signal detection circuit 100 is integrally formed on a single LSI. However, the present invention is not restricted to such an arrangement. Also, a part of the components of the land pre-pit signal detection circuit 100 may be provided in the form of discrete devices, chip components, or multiple LSIs.

Description has been made in the aforementioned embodiments regarding an arrangement in which the land pre-pit signal SigLPP is included at the peak of the push-pull signal SigPP. However, the present invention is not restricted to such an arrangement. Also, an arrangement may be made in which the land pre-pit signal SigLPP is included at the bottom of the push-pull signal SigPP. With such an arrangement, the logical value of each signal is set to the inverse of the value employed in the aforementioned embodiment, thereby properly detecting such a land pre-pit signal SigLPP.

The present invention has been described with reference to the embodiments. It is needless to say that the above-described embodiments represent only mechanisms or applications of the present invention. Accordingly, it is needless to say that various modifications and changes may be made without departing from the spirit of the present invention.

While the preferred embodiments of the present invention have been described using specific terms, such description is for illustrative purposes only, and it is to be understood that changes and variations may be made without departing from the spirit or scope of the appended claims.

What is claimed is:

1. A land pre-pit signal detection circuit for extracting a land pre-pit signal from a push-pull signal, comprising:
a threshold voltage generating circuit which detects the amplitude of a wobble signal included in the push-pull signal, and which generates a threshold voltage based upon the amplitude of the wobble signal thus detected; and
a comparator which compares the push-pull signal with the threshold voltage, and determines whether the land pre-pit signal is present or absent.

2. A land pre-pit signal detection circuit according to claim 1, wherein said threshold voltage generating circuit comprises:
a first filter which removes high-frequency components from the push-pull signal so as to extract the wobble signal;
a peak hold circuit which holds the peak value of the wobble signal thus extracted by said first filter;
a second filter which extracts the DC component from the push-pull signal; and
an amplifier which amplifies the difference between the output of said peak hold circuit and the output of said second filter, thereby generating the threshold voltage which is a predetermined multiple of the amplitude of the wobble signal.

3. A land pre-pit signal detection circuit according to claim 2, wherein said amplifier is a variable-gain amplifier.

4. A land pre-pit signal detection circuit according to claim 2, wherein said threshold voltage generating circuit further includes a voltage dividing circuit which performs voltage dividing using the output of said amplifier and said peak hold circuit,
and wherein the output of said voltage dividing circuit is output as the threshold voltage.

5. A land pre-pit signal detection circuit according to claim 4, wherein said voltage dividing circuit has a configuration which allows the voltage dividing ratio to be adjusted.

6. A land pre-pit signal detection circuit according to claim 1, which is integrally formed on a single semiconductor substrate.

7. An optical disk device comprising:
a pick-up which reads out information that has been written to a disk; and
a land pre-pit signal detection circuit according to claim 1, which detects a land pre-pit signal from a push-pull signal read out by said pick-up.

8. An electronic device including an optical disk device according to claim 7.
